(19) United States
(12) Patent Application Publication
(10) Pub. No.: US 2013/0304506 A1
(43) Pub. Date: Nov. 14, 2013

(54) SYSTEM AND METHOD FOR MANAGING HEALTH RISKS

(71) Applicant: HEALTHENIC INC., Seattle, WA (US)

(72) Inventors: Sean Gallivan, Castle Rock, CO (US); Herbert Ong, Clyde Hill, WA (US); Harvey Kramer Hawks, Seattle, WA (US); Kei Wakabayashi, Issaquah, WA (US); Lisa Zhao, Redmond, WA (US); Ryan Collier, Seattle, WA (US)

(73) Assignee: Healthenic Inc., Seattle, WA (US)

(21) Appl. No.: 13/827,150

(22) Filed: Mar. 14, 2013

Related U.S. Application Data
(60) Provisional application No. 61/644,271, filed on May 8, 2012.

(51) Int. Cl. G06Q 50/24; G06Q 10/10

(52) U.S. Cl. CPC G06Q 50/24; G06Q 10/10
USPC 705/3

(57) ABSTRACT

A method and system for tracking health care metrics over time is disclosed which involves aggregating health related data via computer in a common computer database, de-identifying persons in the data in the database to remove personally identifiable information (PII) and personal Health information (PHI), matching de-identified persons with the related data, analyzing the matched de-identified persons and related data to generate populations utilizing risk, condition, and appropriateness of care algorithms, stratifying the population into predefined groups, identifying opportunities for health improvement, disseminating the opportunities to the persons in the groups; and tracking the groups over time to ascertain success of the opportunities disseminated.

### CROSS REFERENCE TO RELATED APPLICATIONS

This application claims the benefit of priority of U.S. Provisional Application Ser. No. 61/644,271, entitled System and Method for Managing Health Risks, filed May 8, 2012, the content of which is hereby incorporated by reference in its entirety.

### BACKGROUND

The present disclosure broadly relates to management of health care and more particularly to a computerized system and method for effective management of health risks.

The management of health risks, e.g., population health risks, can be expensive and may include the analysis of large amounts of personal health information. Handling personal health information (PHI) is fraught with risk of inadvertent disclosures in violation of privacy requirements both state and federal. In addition, the sheer volume of such information is difficult to manage. However, health care costs are skyrocketing and employers actively seek ways to manage the costs associated with health care. One way of managing such costs is to encourage wellness programs with employees.

Employers invest in wellness initiatives in order to reduce healthcare costs. Such initiatives, to be effective, need to be based on accurate generic data. However, the amount of PHI to be evaluated is monumental and difficult to manage. Typically management and monitoring of health risks are accomplished by focusing on cost strategies based on prior claims. Such strategies are inefficient and generally miss the mark. What is needed is a method and system for managing PHI data to generate meaningful information in such a way that patient privacy is maintained, while effective analysis of trends is monitored in order to generate effective wellness initiatives.

The current methods of cross-referencing information are difficult because of the problem of not having a single ID across different data sets. Therefore there is a need for a tool for cross-referencing and separating personally identifiable information (PII) from PHI in order to facilitate the generation of effective information for trend analysis to generate effective wellness initiatives.

### SUMMARY OF THE DISCLOSURE

One embodiment of the present disclosure is a method for tracking health care metrics over time with recurring data which includes: aggregating all available health data in one place; de-identifying people in the data; matching de-identified people with the data accumulated; analyzing the matched data and population via risk, condition, and appropriateness of care algorithms; placing the population into groups; and identifying opportunities for wellness initiatives based on the results.

Analyzing health care data in accordance with this methodology provides a number of advantages:

1. Aggregation of multiple healthcare sources is expensive, and the results are provided as large amounts of data for analysis. The methodology makes the aggregation of data inexpensive and provides results in a health management dashboard for action.

2. Organizing individuals in appropriateness of care groups provides a new method to monitor and manage population health that is structured to focus efforts on the migration of individuals, rather than cost or single clinical factors.

3. Risk and condition groups can be created from the spectrum of health data, rather than from a single source. This allows a more sophisticated analysis of population health.

4. The methodology automatically identifies and tracks dozens of risk/condition groups concurrently. The display of all groups concurrently also makes unknown and unexpected opportunities visible.

5. Wellness vendors report their successes in a multitude of ways. The methodology provides and measures a consistent set of success metrics for each risk/condition group. The consistent measurement of success will provide an objective comparison between approaches, and providers of services.

PHI data is gathered from various sources, such as patients, medical insurance carriers (claims data and eligibility data), medical service providers (physicians, dentists, hospitals, clinics, etc.), and pharmacies. In raw form, such data is directly correlated and identified to the patient. As part of the gathering, in accordance with the present disclosure, personally identifiable information data is first removed by a process called de-identification. The result is “cleansed” or “de-identified”data. The cleansed data is then cross-matched to identify data into standard data fields. These data fields are used to generate predictive trend information that can help produce the needed programs. Fundamental to this cleansing of data is the need for generating a unique numeric identifier that does not use PII or PHI that can be used to cross reference effective and relevant information.

One embodiment of a method in accordance with this disclosure includes aggregating, utilizing a computing device having a processor operably connected to a database, health care related data associated with patients from sources selected from the group consisting of health insurance carriers, medical providers, dental providers, pharmacies, vision correction providers and individuals; generating a unique identifier for each patient that contains no personal health information (PHI) or personally identifiable information (PII) and matching, using the computing device, the health care related data to the unique identifiers. The method further includes analyzing patient population risks based on the matched health care related data, identifying opportunities for health improvement, and generating suggestions for improvement for members of the patient populations. These suggestions are then disseminated to the members or persons in the groups and then the health related data is tracked over time in order to ascertain the successes of implementation of the suggestions. In particular, the aggregating operation includes collecting data in a common database and de-identifying individuals associated with the data across all data fields so as to remove all PII and PHI.

One embodiment of a system in accordance with the present disclosure includes a computing device having a processor operably connected to a common database and communicatively coupled to health related data sources to receive health related data from those sources. The computing device may be distributed among various locations or may be implemented via networked computer configurations in a well-known manner. The computing device, either standalone or distributed, is basically programmed to aggregate the health related data in the common computer database, de-identify persons in the data in the database to remove personally identifiable information (PII) and personal Health information (PHI), match de-identified persons with the related data, analyze the matched de-identified persons and related data to generate populations utilizing risk, condition, and appropriateness of care algorithms, stratify the population into predefined groups, identify opportunities for health improvement, and disseminate the opportunities to the persons in the groups, and then track health data for the groups over time to ascertain success of the opportunities disseminated.

These and other aspects and advantages, and novel features of this new technology are set forth in part in the description that follows and will become apparent to those skilled in the art upon examination of the following description and figures, or may be learned by practicing one or more embodiments of the technology provided for by the present disclosure.

### BRIEF DESCRIPTION OF THE DRAWINGS

FIG. 1 is a diagram of a computer server system implementing the methodology in accordance with an exemplary embodiment of the present disclosure.

FIG. 2 is a high level view of one embodiment of the method for managing health risks in accordance with the present disclosure.

FIG. 3 is a schematic overview of the methodology shown in FIG. 2.

FIG. 4 is an overview of the data aggregation operation in the embodiment of a method shown in FIG. 2.

FIG. 5 is a schematic overview of the people matching operation in the embodiment of the method shown in FIG. 2.

### DETAILED DESCRIPTION

Reference will now be made in detail to the accompanying drawings, which at least assist in illustrating various pertinent embodiments of the new technology provided for by the present disclosure.

In the following description, for purposes of explanation, numerous specific details are set forth in order to provide a thorough understanding of the description. It will be apparent, however, to one skilled in the art that the invention can be practiced without these specific details. In other instances, structures and devices are shown in block diagram form in order to avoid obscuring the description.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

### System Overview

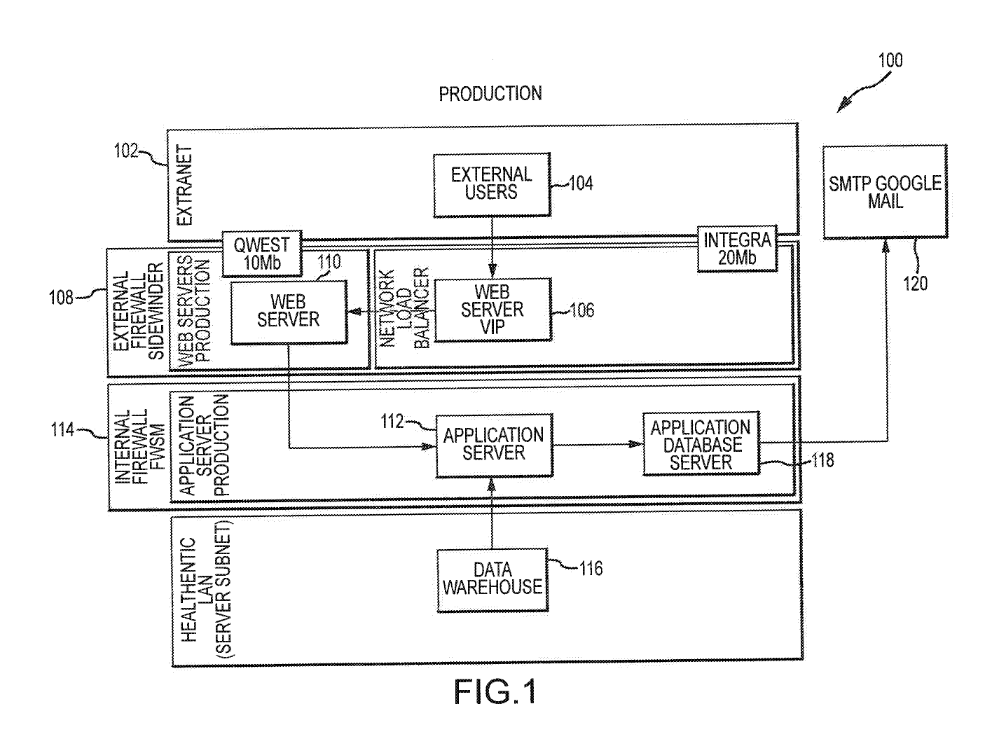

One embodiment of a system for implementing the methodology of managing health risks in accordance with the present disclosure is illustrated in FIG. 1. In the illustrated embodiment, the system 100 includes an extranet 102 encompassing external users 104 submitting data to a network load balancer web server 106 within an external firewall 108. The web server 106 facilitates receipt and balancing of external user data being input into the system 100. The network load balancer web server 106 outputs data to one or more production web servers 110 within the external firewall 108. Other mechanisms for transfer may also be utilized such as via FTP (File Transmission Protocol) to an externally hosted FTP server.

The web servers 110 then provide input to an application server 112 within an internal firewall 114 where data from the processing data warehouse 116 is processed and transferred to an application database server 118. The application database server 118 is also configured to provide external communication via an external communication system 120 such as SMTP Google Mail.

### Methodology Overview

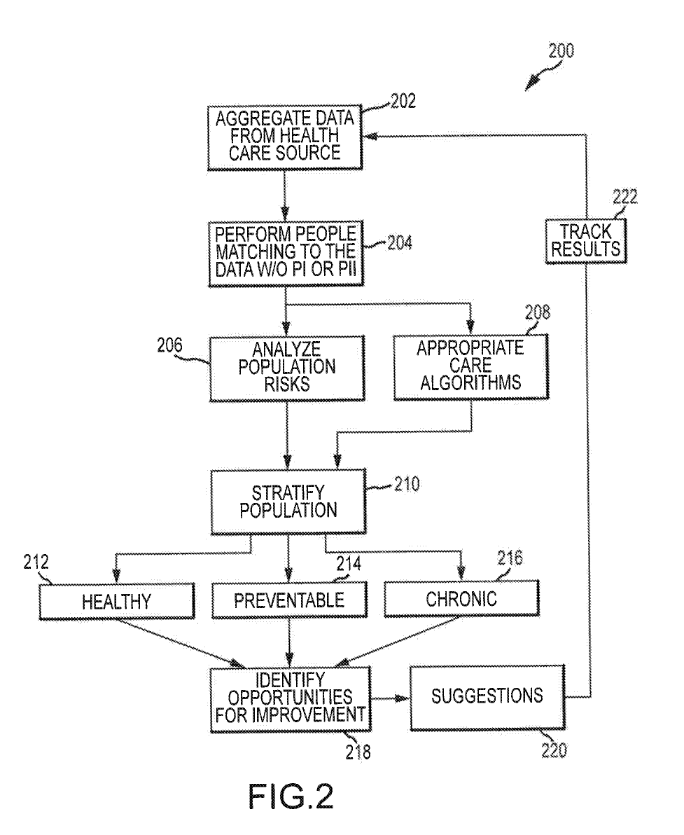

FIG. 2 shows an overview of the process 200 utilized in accordance with the present disclosure. First, in operation 202 data is received from health care data sources such as medical databases, dental records, pharmaceutical, vision, self-reported sources, health risk assessment databases, and other sources such as employee attendance/absence records, disability and work productivity records. This data is collected and transferred to a common database 116. This aggregate data is then manipulated in operation 204 where the individuals associated with the data are de-identified across all of the data fields so as to remove all personally identifiable information (PII) and personal health information (PHI) so that specific identities of the persons is no longer identifiable. The de-identified individuals are then linked to the data throughout all of the aggregated data to generate populations in this overall operation 204.

Then in operation 206, the de-identified individuals in the population are collectively analyzed. For the data generated in operation 204 appropriate care algorithms are also applied to the populations in operation 208.

In operation 210 the populations identified in operations 206 and 208 are stratified into appropriate risk, condition and appropriateness of care group they are to be identified with. For example, the de-identified individuals may be categorized into three groups: healthy 212, preventable 214 and chronic 216. These care groups and risks and conditions that impact those groups are stratified.

Then opportunities can be identified for approaches and providers that offer solutions and enable consistent tracking for each population and/or program. In operation 218, opportunities for improvement of health for the populations are determined and then suggestions are generated in operation 220 for submission back to the individuals in each population. Finally, in operation 222, changes of the results for populations and opportunities are tracked over time for each of the identified approaches.

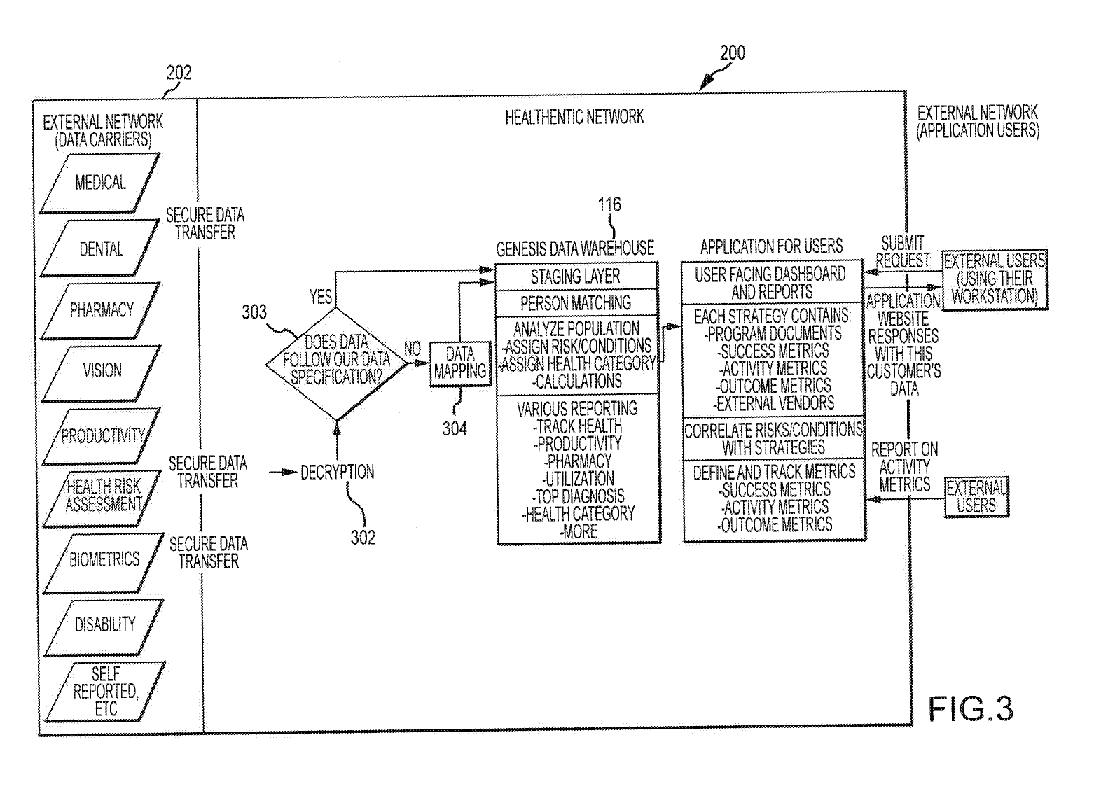

FIG. 3 provides a general picture of how the overall system 200 functions. The various sources or insurance carriers of health related data 202 include medical and dental practitioner records, pharmacy records, vision providers, employer provided productivity records, health risk assessment records, biometric data, disability data and self-reported information. This data contains PII and PHI and therefore must be transferred into the system 200 via secure data transmission. This data must first be decrypted in operation 302. Then the query is made in operation 304 whether the decrypted data follows a predefined data specification. If yes, then the data proceeds to the data warehouse 116. If not, the decrypted data is then mapped into the predefined data specification in mapping operation 304 before transmitting the data to the warehouse 116. The functions performed within the warehouse 116 are summarized in FIG. 3.

The data received is decrypted or de-encrypted by any of a number of currently available methods. For example, GPG (Gnu's Privacy Guard) is preferably utilized. Using Healthentic's private keys and customer's public keys, the files are decrypted and verified to confirm that the files in fact do come from the expected sources. Thus the signature used in data files confirms that the files in fact do come from the sources expected. For example, each data file is checked to ensure that it has the appropriate file extension and file size, and that the file does not contain any invalid characters.

The following paragraphs describe each of the operations that make up the overall methodology in more detail.

### Aggregation of Data

The aggregation of data operation is shown in detail in FIG. 3. The first operation is providing data carrier specific data format. Data specifications are provided in order to facilitate the processing of data. The specifics of the data specifications vary according to the particular data type. The data specification contains the file types, content and format required for data acceptance. The specification ensures that customer data can be processed successfully. Exemplary data specifications for medical claims and pharmacy claims are as follows.

Medical claims data delivery should contain at least five (5) separate files of data and a single Header file listing all files transmitted. File naming should consist of 6 attributes concatenated together and separated by underscores. The following table shows the attributes of the required naming convention:

| Data | | | | Dates Covered | Sequence Number |
|---|---|---|---|---|---|
| type | Customer | Provider | File Type | (yearmonthday_yearmonthday) | (for large files) |
| Med | Acme | Dataprovider | member | 20110101_20110201 | 1 |
| Med | Acme | Dataprovider | claims | 20110101_20110201 | 1 |
| Med | Acme | Dataprovider | claims_diagnosis | 20110101_20110201 | 1 |
| Med | Acme | Dataprovider | claims_diagnosis | 20110101_20110201 | 2 |
| Med | Acme | Dataprovider | claims_diagnosis_procedure | 20110101_20110201 | 1 |
| Med | Acme | dataprovider | provider | 20110101_20110201 | 1 |

The files produced from the table above would be derived as:
1. med_Acme_dataprovider_member_{—}20110101_{—}20110201_{—}1.csv
2. med_Acme_dataprovider_claims_{—}20110101_{—}20110201_{—}1.csv
3. med_Acme_dataprovider_claims_diagnosis_{—}20110101_{—}20110201_{—}1.csv
4. med_Acme_dataprovider_claims_diagnosis_{—}20110101_{—}20110201_{—}2.csv
5. med_Acme_dataprovider_claims_diagnosis_procedure_{—}20110101_{—}20110201_{—}1.csv
6. med_Acme_dataprovider_provider_{—}20110101_{—}20110201_{—}1.csv
   A header should be the last file transferred with the upload. This file signals the completion of the file transfer. The header file naming should follow the same pattern as the csv files being transferred (minus the file_type), but end in “.header”.
<datatype>_<customer>_<data provider>_<dates covered>.header
An example following the same pattern as the files above would be:
med_Acme_dataprovider_{—}20110101_{—}20110201.header
   The contents of the header file should include the names of each of the csv files transferred individually or in the zip file, one file per line, as follows:
med_Acme_dataprovider_member_{—}20110101_{—}20110201_{—}1.csv
med_Acme_dataprovider_claims_{—}20110101_{—}20110201_{—}1.csv
med_Acme_dataprovider_claims_diagnosis_{—}20110101_{—}20110201_{—}1.csv
med_Acme_dataprovider_claims_diagnosis_{—}20110101_{—}20110201_{—}2.csv
med_Acme_dataprovider_claims_diagnosis_procedure_{—}20110101_{—}20110201_.csv
med_Acme_dataprovider_provider_{—}20110101_{—}20110201_{—}1.csv
   If a file is listed in the header file but is not included in the upload, the upload will be treated as incomplete and will not be loaded.

### Member File:

To allow integration of different data sets for a customer, but maintain limited stores of Personal Health Information (PHI), only certain fields will be used which contain PHI. These fields are italicized and are:
SSN
CLEAR_MEMBER_NO
EMPLOYEE_NO
   It is important to include member information for all members regardless of whether or not they have a claim.

| Name | Data Type | Requirement | Notes |
|---|---|---|---|
| MEMBER_NO | varchar(25) | Required | The unique identifier assigned to the member for a period of coverage. This |
| | | | must be de-identified so as to not be usable to identify the person outside of |
| | | | this data set. |
| EMPLOYEE_FLAG | bit | Preferred | Indicates if the person is an employee of the Customer. |
| | | | 1 = Employee, 0 = Non-employee |
| YEAR_OF_BIRTH | Int | Required | Year of birth of the person - full DOB is acceptable here and month and day |
| | | | will be stripped upon load. |
| SSN | varchar(4) | Preferred | SSN of the person. Send only the last 4 digits. |
| GENDER | char(1) | Required | Gender of the person, use the following values: |
| | | | M = Male; F = Female; U = Unknown |
| | | | (Defaults to “U” if empty) |
| SUB_MEMBER_NO | varchar(25) | Required | The subscriber's unique identifier. (The subscriber is the primary member for a |
| | | | family.) If this is the same as the member's number, enter the member number. |
| | | | (See notes for MEMBER_NO.) This must be de-identified so as to not be |
| | | | usable to identify the person outside of this data set. |
| PLAN_TYPE | varchar(25) | Required | Default to “Medical”. |
| ENROLLMENT_TYPE | varchar(25) | Required | Denotes if the member is the Subscriber or Dependent, us the following |
| | | | values: |
| | | | Sub |
| | | | Dep |
| ACTIVE_STATUS | varchar(25) | Preferred | Indicates the Subscriber's employment status for enrollment, the following |
| | | | values should be used: |
| | | | Active |
| | | | COBRA |
| | | | Retired |
| DATE_COVERAGE_EFFECTIVE | date | Required | Date the member's medical coverage segment became effective. |
| | | | If a gap in coverage of more than 1 day exists, multiple records should be sent, |
| | | | each displaying the medical coverage effective date of the segment - not the |
| | | | first overall effective date. |
| | | | The date format is YYYY-MM-DD (eg 2010-01-31) |
| DATE_COVERAGE_TERMINATED | date | Required* | Date the member's medical coverage segment terminated. |
| | | | If the member is still eligible and does not have a termination date, this field |
| | | | should be left NULL. If a member has multiple coverage segments, the |
| | | | termination date of the segment should be listed on the same row as the |
| | | | corresponding eligibility effective date. Only the most current, active eligibility |
| | | | segment should have a NULL value in this field if the member is still eligible. |
| | | | The date format is YYYY-MM-DD (eg 2010-01-31) |
| CLEAR_MEMBER_NO | varchar(25) | Preferred | The clear (not de-identified) value for MEMBER_NO for the person. |
| EMPLOYEE_NO | varchar(25) | Preferred | The customer-assigned employee number for the person, if the person is the |
| | | | primary subscriber. If the person is a dependent, leave NULL. |
| MARITAL_STATUS | varchar(1) | Preferred | The current marital status of the member. Use the following values: |
| | | | S = Single |
| | | | M = Married |
| | | | D = Divorced |
| | | | W = Widow/Widower |
| | | | P = Domestic Partner |
| | | | U = Unknown |
| | | | (Defaults to “U” if empty) |
| RELATIONSHIP_TYPE | int | Preferred | The relationship of the dependent to the subscriber. Use the following values: |
| | | | 0 - Not Specified |
| | | | 1 - Member |
| | | | 2 - Spouse/Partner |
| | | | 3 - Child |
| | | | 4 - Student |
| | | | 5 -Disabled dependent |
| | | | 6 - Dependent Parent |
| | | | (Defaults to 0 if empty) |

### Claims File:

| Name | Data Type | Requirement | Notes |
|---|---|---|---|
| CLAIM_NUMBER | varchar(50) | Required | Customer specific ID to represent a claim. |
| | | | Should not be a unique table key, but a unique number per claim |
| | | | encounter so that adjustments or reversals to the claim encounter |
| | | | can be linked |
| LINE_NUMBER | tinyint | Required | Claim line number. |
| ADJUSTMENT_CD | varchar(5) | — | Default to NULL |
| MEMBER_NO | VARCHAR(25) | Required | Member for which the claim pertains to - this is the person that |
| | | | received the service. This number should correspond to the |
| | | | MEMBER_NO within the Member File. |
| PRIMARY_CARE_PROVIDER_NO | VARCHAR(25) | Preferred | Provider number for the member's assigned primary care provider. |
| | | | This number should correspond to the PROVIDER_NO within the |
| | | | Provider File. |
| SERVICE_PROVIDER_NO | VARCHAR(25) | Preferred | Provider number for the provider of service. This number should |
| | | | correspond to the PROVIDER_NO within the Provider File. |
| ATTENDING_PROVIDER_NO | VARCHAR(25) | Optional | Provider number for the attending provider (pertains to inpatient |
| | | | professional services). This number should correspond to the |
| | | | PROVIDER_NO within the Provider File. |
| BILLING_PROVIDER_NO | VARCHAR(25) | Optional | Provider number for the billing provider. This number should |
| | | | correspond to the PROVIDER_NO within the Provider File. |
| DATE_OF_SERVICE_BEGIN | date | Required | Beginning date of service. For individual visits, this should be the |
| | | | date of service. For inpatient services, this should be the date of |
| | | | the member was admitted to the hospital or other inpatient facility. |
| | | | The date format is YYYY-MM-DD (eg 2010-01-31) |
| DATE_OF_SERVICE_END | date | Required | End date of service. For same day visits, enter the same date at the |
| | | | DATE_OF_SERVICE_BEGIN. For inpatient services, this should |
| | | | be the date the member is discharged from the hospital or other |
| | | | inpatient setting. |
| | | | The date format is YYYY-MM-DD (eg 2010-01-31) |
| DATE_PAID | date | Preferred | Date the claim was paid. Claims that have not been adjudicated and |
| | | | paid should be excluded from the file. |
| | | | The date format is YYYY-MM-DD (eg 2010-01-31) |
| CLAIM_GROUP_CATEGORY_CD | varchar(5) | — | Default to NULL |
| PLACE_OF_SERVICE_CD | varchar(5) | Required | Location that the service took place. See LOOKUP table |
| | | | PLACE_OF_SERVICE (Part IV, Section a) for accepted values |
| PROCEDURE_CD | varchar(5) | Preferred | CPT code associated with the claim line. Use all currently valid |
| | | | and recognized HCPCS values as submitted on a claim. |
| PROCEDURE_DESC | varchar(200) | Preferred | Description of the CPT code associated with the claim line. |
| DRG_CD | varchar(5) | Preferred | DRG code associated with the claim - will pertain to Inpatient |
| | | | claims only. Include leading zeroes where present. |
| DRG_DESC | varchar(200) | Optional | DRG description associated with the DRG code |
| DRG_VERSION | varchar(20) | Preferred | Version or Revision Date |
| DRG_TYPE | varchar(20) | Preferred | Healthentic recognizes the use of MS-DRG codes in our warehouse. |
| | | | Include the type of DRG code so MS-DRG codes are validated and code |
| | | | sets other than MS-DRG are known, i.e., ‘AP’, ‘AP-DRG’, etc. |
| ADMIT_TYPE_CD | varchar(5) | Optional | Admission Type code associated with the claim - will pertain to |
| | | | Inpatient claims only. See LOOKUP table ADMIT_TYPE (Part IV, |
| | | | Section d) for accepted values. |
| DISCHARGE_DISPOSITION_CD | varchar(5) | Preferred | Discharge Disposition code associated with the claim - include for |
| | | | Inpatient claims only. This is a standard code set required on claims |
| | | | (UB Field 17). See LOOKUP table DISCHARGE_DISPOSITION |
| | | | (Part IV, Section c) for accepted values. |
| TYPE_OF_SERVICE_CD | varchar(5) | Preferred | Indicates the type of service provided. See LOOKUP table |
| | | | TYPE_OF_SERVICE (Part IV, section e) for accepted values. |
| PATIENT_RESP_AMOUNT | money | Required | The total dollar amount that the patient is responsible for. |
| | | | This would include the sum of all patient responsibility values |
| | | | such as co-pay, deductible, co-insurance, etc. |
| PATIENT_COINSURANCE | money | Preferred | The patient's co-insurance applied to the claim line. |
| BILLED_AMOUNT | money | Preferred | Amount billed on a claim for this line. |
| ALLOWED_AMOUNT | money | Preferred | Total amount allowed for the procedure billed. This is the amount |
| | | | per a provider's contract or patient's benefit plan that specifies |
| | | | the total payable after provider write-offs. |
| APPROVED_AMOUNT | money | Preferred | Amount approved for payment by the plan minus patient responsibility |
| | | | for this line item. |
| PAID_AMOUNT | money | Required | Amount paid to the provider on a claim for this line. |
| CLAIM_STATUS | varchar(1) | Required | Final status of the claim overall. Status per claim line is not |
| | | | necessary, this value will repeat for all lines on a claim. |
| | | | P = Paid |
| | | | D = Denied |
| | | | R = Reversed |
| BILL_TYPE | varchar(3) | Optional | The 3 digit type of bill code on the claim. This will only apply to |
| | | | inpatient claims. |
| REV_CD | varchar(4) | Optional | The revenue code submitted on the claim. This will only apply to |
| | | | inpatient claims. |

### Claim Diagnosis File:

(There are Multiple Possible Diagnosis Codes Per Claim)

| Name | Data Type | Requirement | Notes |
|---|---|---|---|
| CLAIM_NUMBER | varchar(50) | Required | Customer specific ID to represent a claim. |
| | | | Should not be a unique table key, but a unique number per claim encounter |
| | | | so that adjustments or reversals to the claim encounter can be linked. This |
| | | | must match the CLAIM_NUMBER in he Claims file. |
| DIAGNOSIS_CD | varchar(25) | Required | Diagnosis code (ICD9) associated with the claim line, multiple values are |
| | | | handled in order by the SEQUENCE. Use all currently recognized ICD-9-CM |
| | | | values as submitted on a claim. Either Dot notation or No Dot Notation |
| | | | is acceptable. |
| DIAGNOSIS_DESC | varchar(200) | Preferred | Description associated with the diagnosis code. |
| SEQUENCE | smallint | Required | Incrementing integer value beginning at 1. |
| | | | The primary diagnosis should receive the value of 1. The order of diagnosis |
| | | | codes after that is arbitrary, but no sequence number should repeat per claim. |

### Claim ICD-9-CM Procedure File (Claim Diagnosis Procedure File)

(There are Multiple Possible ICD-9-CM Procedure Codes Per Claim)

| Name | Data Type | Requirement | Notes |
|---|---|---|---|
| CLAIM_NUMBER | varchar(50) | Required | Customer specific ID to represent a claim. |
| | | | Should not be a unique table key, but a unique number per claim encounter |
| | | | so that adjustments or reversals to the claim encounter can be linked. This |
| | | | must match the CLAIM_NUBMER in he Claims file. |
| DX_PROC_CD | varchar(25) | Required | Procedure code (ICD9_PROC) associated with the claim line, multiple values |
| | | | are handled in order by the SEQUENCE. Use all currently recognized ICD-9-CM |
| | | | Procedure values as submitted on a claim. |
| DX_PROC_DESC | varchar(200) | Preferred | Description associated with the procedure code. |
| SEQUENCE | smallint | Required | Incrementing integer value beginning at 1. |
| | | | The primary diagnosis procedure code should receive the value of 1. The |
| | | | order thereafter is arbitrary, but no sequence number should repeat per claim. |

### Provider File:

| Name | Data Type | Requirement | Notes |
|---|---|---|---|
| PROVIDER_NO | varchar(25) | Required | Customer unique identifier for each provider. |
| PROVIDER_TYPE | varchar(1) | Preferred | Indicates whether the provider is a person or an organization. The following |
| | | | are acceptable values for this field: |
| | | | F = Facility/Clinic |
| | | | P = Person |
| NPI | varchar(10) | Preferred | Provider's National Provider Identifier. |
| TIN | varchar(14) | Optional | Provider's Federal Tax ID Number. |
| DEA_NO | varchar(15) | Optional | Provider's DEA Number. |
| PROVIDER_SPECIALTY_CD | varchar(5) | Required | List the specialty of the provider using the standard provider specialty codes. |
| | | | See LOOKUP table PROVIDER_SPECIALTY (Part IV, Section b) for |
| | | | accepted values. |
| FACILITY_NAME | varchar(125) | Preferred | Name of the Facility or Clinic. If the provider is a person and practices |
| | | | at a Clinic, list the name of that clinic here. |
| FIRST_NAME | varchar(50) | Preferred | First name of the provider, NULL if Facility. |
| MIDDLE_INITIAL | varchar(1) | Optional | Middle Initial of the provider, NULL if Facility. |
| LAST_NAME | varchar(50) | Preferred | Last name of the provider, NULL if Facility. |
| SUFFIX | varchar(8) | Optional | Suffix of the provider, NULL if Facility. |
| PREFIX | varchar(15) | Optional | Prefix of the provider, NULL if Facility. |
| DATE_OF_BIRTH | date | Optional | Date of birth of the provider, NULL if Facility. The date format is |
| | | | YYYY-MM-DD (eg 2010-01-31) |
| GENDER | char(1) | Optional | Gender of the provider, NULL if Facility. |

Exemplary data specifications for transmission of pharmacy data are provided in the following paragraphs. Pharmaceutical claims data delivery should contain at least four (4) separate files of data and a single Header file listing all files transmitted. File naming should consist of 6 attributes concatenated together and separated by underscores. The following table shows the attributes of the required naming convention:

| Data | | | | Dates Covered | Sequence Number |
|---|---|---|---|---|---|
| type | Customer | Data Provider | File Type | (yearmonthday_yearmonthday) | (for large files) |
| rx | Acme | Dataprovider | member | 20110101_20110201 | 1 |
| rx | Acme | Dataprovider | pharmacy claims | 20110101_20110201 | 1 |
| rx | Acme | Dataprovider | pharmacy claims | 20110101_20110201 | 2 |
| rx | Acme | Dataprovider | provider | 20110101_20110201 | 1 |
| rx | Acme | Dataprovider | pharmacy | 20110101_20110201 | 1 |

The files produced from the table above would be derived as:
1. rx_Acme_Dataprovider_member_{—}20110101_{—}20110201_{—}1.csv
2. rx_Acme_Dataprovider_pharmacy_claims_{—}20110101_{—}20110201_{—}1.csv
3. rx_Acme_Dataprovider_pharmacy_claims_{—}20110101_{—}20110201_{—}2.csv
4. rx_Acme_Dataprovider_provider_{—}20110101_{—}20110201_{—}1.csv
5. rx_Acme_Dataprovider_pharmacy_{—}20110101_{—}20110201_{—}1.csv

Member File:

To allow integration of different data sets for a customer, but maintain limited stores of Personal Health Information (PHI), only certain fields will be used which contain PHI. These fields are italicized and are:
SSN
CLEAR_MEMBER_NO
EMPLOYEE_NO

It is important to include member information for all members regardless of whether or not they have a claim.

| Name | Data Type | Requirement | Notes |
|---|---|---|---|
| MEMBER_NO | varchar(25) | Required | The unique identifier assigned to the member for a period of coverage. This |
| | | | must be de-identified so as to not be usable to identify the person outside |
| | | | of this data set. |
| EMPLOYEE_FLAG | bit | Preferred | Indicates if the person is an employee of the Customer. |
| | | | 1 = Employee, 0 = Non-employee |
| YEAR_OF_BIRTH | Int | Required | Year of birth of the person - full DOB is acceptable here and month and day |
| | | | will be stripped upon load. |
| SSN | varchar(4) | Preferred | SSN of the person. Send only the last 4 digits. |
| GENDER | char(1) | Required | Gender of the person, use the following values: |
| | | | M = Male; F = Female; U = Unknown |
| | | | (Defaults to “U” if empty) |
| SUB_MEMBER_NO | varchar(25) | Required | The subscriber's unique identifier. (The subscriber is the primary member for |
| | | | a family.) If this is the same as the member's number, enter the member number. |
| | | | (See notes for MEMBER_NO.) This must be de-identified so as not to be usable |
| | | | to identify the person outside of this data set. |
| PLAN_TYPE | varchar(25) | Required | Type of coverage the eligible member is enrolled in, use the following values: |
| | | | Medical |
| | | | Pharmacy |
| | | | Dental |
| ENROLLMENT_TYPE | varchar(25) | Required | Denotes if the member is the Subscriber or Dependent, use the following values: |
| | | | Sub |
| | | | Dep |
| ACTIVE_STATUS | varchar(25) | Preferred | Indicates the Subscriber's employment status for enrollment; the following |
| | | | values should be used: |
| | | | Active |
| | | | COBRA |
| | | | Retired |
| DATE_COVERAGE_EFFECTIVE | date | Required | Date the member's coverage became effective with the plan listed. |
| | | | The date format is YYYY-MM-DD (eg 2010-01-31) |
| DATE_COVERAGE_TERMINATED | date | Required* | Date the member's coverage terminated with the plan listed. |
| | | | The date format is YYYY-MM-DD (eg 2010-01-31) |
| | | | *If the member is still active and does not have a termination date, this |
| | | | field can be left NULL. |
| CLEAR_MEMBER_NO | varchar(25) | Preferred | The clear (not de-identified) value for MEMBER_NO for the person. |
| EMPLOYEE_NO | varchar(25) | Preferred | The customer-assigned employee number for the person, if the person is |
| | | | the primary subscriber. If the person is a dependent, leave NULL. |
| MARITAL_STATUS | varchar(1) | Preferred | The current marital status of the member. Use the following values: |
| | | | S = Single |
| | | | M = Married |
| | | | D = Divorced |
| | | | W = Widow/Widower |
| | | | P = Domestic Partner |
| | | | U = Unknown |
| | | | (Defaults to “U” if empty) |
| RELATIONSHIP_TYPE | int | Preferred | The relationship of the dependent to the subscriber. Use the following values: |
| | | | 0 - Not Specified |
| | | | 1 - Member |
| | | | 2 - Spouse/Partner |
| | | | 3 - Child |
| | | | 4 - Student |
| | | | 5 -Disabled dependent |
| | | | 6 - Dependent Parent |
| | | | (Defaults to 0 if empty) |

Pharmacy Claims File

| Name | Data Type | Requirement | Notes |
|---|---|---|---|
| PRESCRIPTION_NO | varchar(50) | Required | Customer specific ID to represent a pharmacy claim encounter (must create |
| | | | a unique key when coupled with REFILL_NUMBER and ADJUSTMENT_CD). |
| | | | This must be masked so as not to be usable to identify the person outside |
| | | | of this data set. |
| REFILL_NUMBER | tinyint | Required | Refill number of the prescription being filled (must create a unique key |
| | | | when coupled with PRESCRIPTION_NUMBER and ADJUSTMENT_CD). |
| | | | Set to 0 when prescription is filled for the first time. |
| ADJUSTMENT_CD | varchar(5) | Required | Adjustment code to indicate if the claim is a reversal or an adjustment. This |
| | | | field will be NULL if the claim was never reversed or adjusted. For claims |
| | | | with multiple adjustments/reversals, increment the 1 as needed. Use the following |
| | | | values: |
| | | | A1 - first adjustment in date order |
| | | | R1 - first reversal in date order |
| | | | A2 - second adjustment in date order |
| | | | R2 - second reversal in date order |
| | | | (additional as needed) |
| MEMBER_NO | varchar(25) | Required | Member who the prescription claim pertains to. This number should correspond |
| | | | to the MEMBER_NO within the Member File. |
| NDC_CD | varchar(11) | Required | National Drug Code - unique identifier for the drug dispensed. |
| NDC_DESC | varchar(255) | Preferred | Nation Drug Code Description. |
| GENERIC_INDICATOR | int | Preferred | Generic = 1 Non-Generic = 0 |
| PRESCRIBING_PROVIDER_NO | varchar(25) | Preferred | Provider number for the provider that wrote the prescription. This number |
| | | | should correspond to the PROVIDER_NO within the Provider File. |
| PHARMACY_NO | varchar(25) | Preferred | Unique identifier of the dispensing pharmacy. |
| DATE_DISPENSED | date | Required | Date that the prescription was dispensed. The date format is YYYY-MM-DD |
| | | | (eg 2010-01-31) |
| DATE_PAID | date | Optional | Date the claim was paid (this will usually be the dispense date). The date |
| | | | format is YYYY-MM-DD (eg 2010-01-31) |
| DAYS_SUPPLY | int | Required | Number of days the prescription dispensed is intended to last. |
| PATIENT_RESP_AMOUNT | money | Required | The total dollar amount that the patient is responsible for. This would |
| | | | include the sum of all patient responsibility values such as co-pay, |
| | | | deductible, co-insurance, etc. |
| PATIENT_COINSURANCE | money | Preferred | The patient's co-insurance applied for the prescription. |
| BILLED_AMOUNT | money | Preferred | Amount billed for the prescription. |
| ALLOWED_AMOUNT | money | Preferred | Total amount allowed for the prescription billed. This is the amount per |
| | | | a provider's contract or patient's benefit plan that specifies the total |
| | | | payable after provider write-offs. |
| APPROVED_AMOUNT | money | Preferred | Amount approved for payment by the plan minus patient responsibility for |
| | | | this line item. |
| PAID_AMOUNT | money | Required | Amount paid to the Pharmacy for the prescription. |
| CLAIM_STATUS | varchar(1) | Required | Final status of the claim overall. Status per claim line is not necessary, |
| | | | this value will repeat for all lines on a claim. |
| | | | P = Paid |
| | | | D = Denied |
| | | | R = Reversed |

Provider File

| Name | Data Type | Requirement | Notes |
|---|---|---|---|
| PROVIDER_NO | varchar(25) | Required | Customer unique identifier for each provider. |
| PROVIDER_TYPE | varchar(1) | Preferred | Indicates whether the provider is a person or an organization. The following |
| | | | are acceptable values for this field: |
| | | | F = Facility/Clinic |
| | | | P = Person |
| NPI | varchar(10) | Preferred | Provider's National Provider Identifier. |
| TIN | varchar(14) | Optional | Provider's Federal Tax ID Number. |
| DEA_NO | varchar(15) | Optional | Provider's DEA Number. |
| PROVIDER_SPECIALTY_CD | varchar(5) | Required | List the specialty of the provider using the standard provider specialty codes. |
| | | | See LOOKUP table PROVIDER_SPECIALTY (Part IV, Section A) for |
| | | | accepted values. |
| FACILITY_NAME | varchar(125) | Preferred | Name of the Facility or Clinic. If the provider is a person and practices |
| | | | at a Clinic, list the name of that clinic here. |
| FIRST_NAME | varchar(50) | Preferred | First name of the provider, NULL if Facility. |
| MIDDLE_INITIAL | varchar(1) | Optional | Middle Initial of the provider, NULL if Facility. |
| LAST_NAME | varchar(50) | Preferred | Last name of the provider, NULL if Facility. |
| SUFFIX | varchar(8) | Optional | Suffix of the provider, NULL if Facility. |
| PREFIX | varchar(15) | Optional | Prefix of the provider, NULL if Facility. |
| DATE_OF_BIRTH | date | Optional | Date of birth of the provider, NULL if Facility. The date format is |
| | | | YYYY-MM-DD (eg 2010-01-31) |
| GENDER | char(1) | Optional | Gender of the provider, NULL if Facility. |

Pharmacy File

| Name | Data Type | Requirement | Notes |
|---|---|---|---|
| PHARMACY_NO | varchar(25) | Required | Unique identifier for each pharmacy. |
| SECONARY_PHARMACY_NO | varchar(25) | Optional | Secondary ID to identify a Pharmacy. Should match the |
| | | | SECONDARY_PHARMACY_NO_TYPE. |
| SECONARY_PHARMARCY_NO_TYPE_CD | varchar(3) | Optional | See LOOKUP table PHARMACY NUMBER TYPE CODES |
| | | | (Part IV, Section b) for accepted values. Select one type to |
| | | | include in the file. All Secondary numbers should be of |
| | | | this selected type. |
| PHARMACY_CHAIN | varchar(75) | Optional | Name of the chain that the pharmacy branch belongs to, if |
| | | | applicable. |
| PHARMACY_NAME | varchar(125) | Required | Name of the location that the prescriptions are dispensed at, |
| | | | i.e., the specific branch of a larger chain. |
| CITY | varchar(25) | Preferred | City of the Pharmacy's physical location. |
| STATE | varchar(2) | Preferred | State of the Pharmacy's physical location. |
| ZIP | varchar(5) | Preferred | Zip code of the Pharmacy's physical location. |

An exemplary table of provider specialty codes is as follows:

| Provider | |
|---|---|
| Specialty Code | Description |
| 1 | General practice |
| 2 | General surgery |
| 3 | Allergy/immunology |
| 4 | Otolaryngology |
| 5 | Anesthesiology |
| 6 | Cardiology |
| 7 | Dermatology |
| 8 | Family practice |
| 9 | Interventional pain management |
| 10 | Gastroenterology |
| 11 | Internal medicine |
| 12 | Osteopathic manipulative therapy |
| 13 | Neurology |
| 14 | Neurosurgery |
| 15 | Speech language pathology |
| 16 | Obstetrics/gynecology |
| 17 | Hospice and palliative Care |
| 18 | Ophthalmology |
| 19 | Oral surgery (dentist only) |
| 20 | Orthopedic surgery |
| 22 | Pathology |
| 24 | Plastic and reconstructive surgery |
| 25 | Physical medicine and rehabilitation |
| 26 | Psychiatry |
| 27 | Geriatric psychiatry |
| 28 | Colorectal surgery |
| 29 | Pulmonary disease |
| 30 | Diagnostic radiology |
| 32 | Anesthesiologist assistant |
| 33 | Thoracic surgery |
| 34 | Urology |
| 35 | Chiropractic |
| 36 | Nuclear medicine |
| 37 | Pediatric medicine |
| 38 | Geriatric medicine |
| 39 | Nephrology |
| 40 | Hand surgery |
| 41 | Optometry |
| 42 | Certified nurse midwife |
| 43 | Certified registered nurse anesthetist (CRNA) |
| 44 | Infectious disease |
| 45 | Mammography screening center |
| 46 | Endocrinology |
| 47 | Independent diagnostic testing facility |
| 48 | Podiatry |
| 49 | Ambulatory surgical center |
| 50 | Nurse practitioner |
| 51 | Medical supply company with certified orthotist |
| 52 | Medical supply company with certified prosthetist |
| 53 | Medical supply company with certified prosthetist- |
| | orthotist |
| 54 | Medical supply company not included in specialties |
| | 51-53 |
| 59 | Ambulance service (private) |
| 63 | Portable x-ray supplier |
| 64 | Audiologist (billing independently) |
| 65 | Physical therapist (private practice) |
| 66 | Rheumatology |
| 67 | Occupational therapist (private practice) |
| 68 | Clinical psychologist |
| 69 | Clinical laboratory (billing independently) |
| 70 | Multi-specialty clinic or group practice |
| 71 | Dietitian/nutritionist (effective Jan. 1, 2002) |
| 72 | Pain management (effective Jan. 1, 2002) |
| 73 | Mass immunization roster biller |
| 74 | Radiation therapy center |
| 75 | Slide preparation facility |
| 76 | Peripheral vascular disease |
| 77 | Vascular surgery |
| 78 | Cardiac surgery |
| 79 | Addiction medicine |
| 80 | Licensed clinical social worker |
| 81 | Critical care |
| 82 | Hematology |
| 83 | Hematology/oncology |
| 84 | Preventative medicine |
| 85 | Maxillofacial surgery |
| 86 | Neuropsychiatry |
| 87 | All other (drug and department store, etc.) |
| 88 | Unknown supplier/provider |
| 89 | Certified clinical nurse specialist |
| 90 | Medical oncology |
| 91 | Surgical oncology |
| 92 | Radiation oncology |
| 93 | Emergency medicine |
| 94 | Interventional radiology |
| 96 | Optician |
| 97 | Physician assistant |
| 98 | Gynecological/oncology |
| 99 | Uknown physician specialty |
| 200 | Pharmacy |
| 201 | Dentistry |
| 202 | Sleep medicine |
| 203 | Alternative Medicine |
| 204 | Behavioral Health |
| 205 | Home Health |
| 206 | Individual/Family Therapist |
| 207 | Medical Genetics |
| 208 | Neonatology |

An exemplary table of pharmacy type number codes is set forth below.

| Pharmacy Number Type Code | Description |
|---|---|
| 00 | Not specified |
| 01 | NPI |
| 02 | Blue Cross |
| 03 | Blue Shield |
| 04 | Medicare |
| 05 | Medicaid |
| 06 | UPIN |
| 07 | NCPDP Provider Identification Number |
| 08 | State License |
| 09 | CHAMPUS |
| 10 | HIN |
| 11 | Federal Tax ID |
| 12 | DEA Number |
| 13 | State Issued |
| 14 | Plan Specific |
| 15 | HCID (Health Care Institution Identifier |
| | by AP Health Institutions) |
| 99 | Other |

Dental record and dental provider data is handled in a similar manner as the medical and pharmacy data shown above and therefore is not shown in this specification for the sake of brevity. Health data may include eligibility and/or claims data. Eligibility data refers to a person's active enrollment with an insurance plan that provides benefits for health care during predefined dates. This data also specifies whether a person is enrolled as a Subscriber, Dependent, or has dual eligibility. Claims data is defined as the data collected by insurance plan containing services, costs, and diagnosis/procedures/drug or other terminology codes from a provider or facility to facilitate the adjudication and payment of health insurance benefits on behalf of the plan's enrolled members. As indicated in the tables above, claims data may include personal identification information (PII) and/or personal health information (PHI). The health data is received by secure transfer from the external network of insurance carriers, providers and other sources 202 as described above.

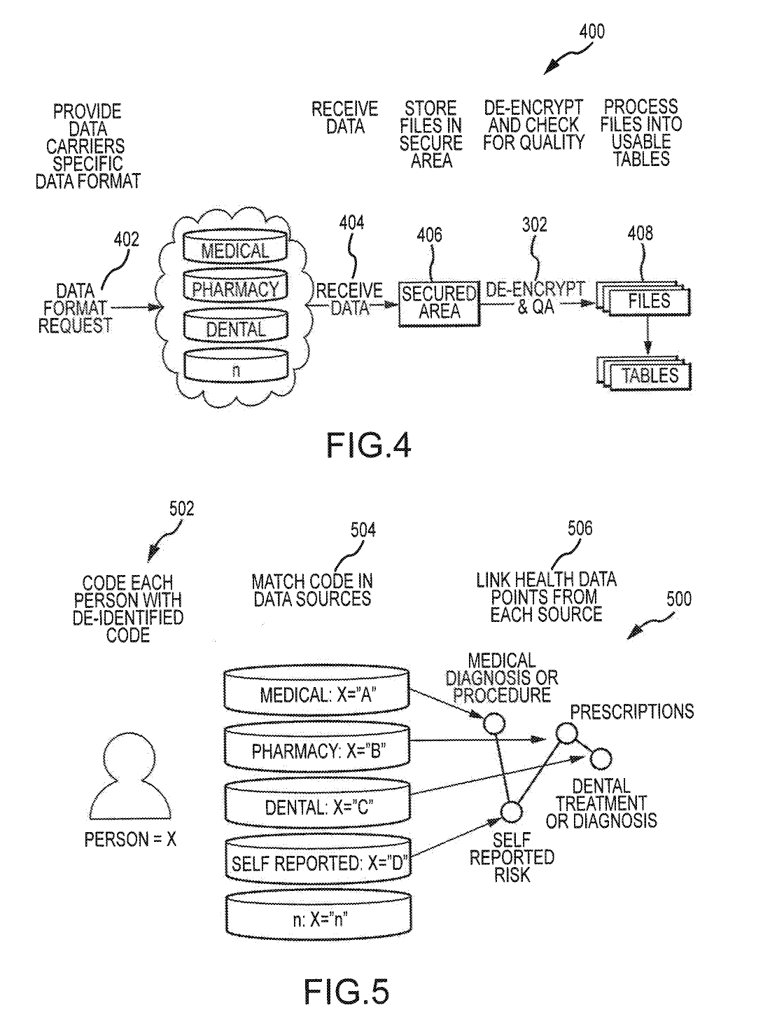

In general, this aggregation process 400 is illustrated in FIG. 4. In operation 402 data is requested from the carriers as described above. This data is received in operation 404 in a secure area 406 and De-encrypted in operation 302 described above. The decrypted data is then stored in tables and in files 408 for subsequent use.

The health data first is mapped to the standard database format following decryption. This is done in a staging layer, shown in FIG. 3. From staging, all data is put through the same set of rules to maximize data integrity and ensure a uniform data warehouse, including: person matching, foreign key lookups, and removal of claims that do not match to persons or periods of eligibility. Data that fails to load is reported in error tables with custom error messages for investigation. Recurring data files are accepted and processed using a standard Change Data Capture approach, i.e., inserting new rows and updating modified rows (identified by joining on a pre-defined business key). Data is not deleted from the data warehouse. Rather, it is marked inactive if no longer valid. The same set of data cleansing rules is used on all customer data including person matching, foreign key lookups, and removal of claims that do not match to persons or periods of eligibility. Exemplary detailed mapping rules are provided below.

Healthentic transforms each customer's unique raw data format to match the data specification for our data warehouse using SQL scripts which incorporate the following logic:
Identifying inpatient claims:
   Map unknown or unreliable DRGs as 999
   Filter out place of service when data is unreliable
   Filter out discharge disposition for outpatient claims
Enabling person matching between data sets using one of the standard person matching scenarios by providing the required data for the target scenario and excluding data only used by other scenarios, using the following matrix:

| | Scenarios | | | | | |
|---|---|---|---|---|---|---|
| Field | 1 | 2 | 3 | 4 | 5 | 8 |
| CLEAR_MEMBER_NO | N | N | N | Y | S-Y, | I |
| | | | | | D-N | |
| EMPLOYEE_NO | S-Y | N | N | N | N | I |
| | D-N | | | | | |
| GENDER | D-Y | Y | Y | I | D-Y | I |
| MEMBER_NO | I | I | I | I | I | Y |
| SSN | N | Y | S-Y | N | N | I |
| | | | D-N | | | |
| SUB_MEMBER_NO | D-Y | I | D-Y | I | D-Y | I |
| YEAR_OF_BIRTH | D-Y | Y | Y | I | D-Y | I |

N = Null
Y = Must be populated
I = Ignore; not used
S = Subscriber
D = Dependent

Enabling person matching between data sets when the standard person matching fields are not available:
   Create a custom member crosswalk, or
   Create a hashed custom member ID based on other fields common to the data sets
Handling claim adjustments:
   If a raw file contains a field that indicates a reversal, send an ADJUSTMENT_CD=‘R’ and negative dollars (−$)
   If a raw file contains a field that indicates an adjustment, send ADJUSTMENT_CD=‘A’ and dollars through as is in the file
   If a raw file does NOT contain a field that indicates an adjustment, but does contains fields with negative dollars, send the dollar fields through as is and an ADJUSTMENT_CD=‘R’
   Send all other records with ADJUSTMENT_CD NULL and dollar fields as is.
   If claims are sent as a point-in-time snapshot, send an ADJUSTMENT_CD=‘X’
Identifying primary diagnosis code:
   If not provided in the customer data set, consider the first diagnosis code of the claim lines to the be primary diagnosis code for the claim.
   The query should be written in such a way as to throw out duplicate primaries by taking the minimum value of the primary diagnosis or equivalent field.
Additional logic for member fields:
   DATE_COVERAGE_TERMINATED: Set to ‘9999-12-31’ or null for open-ended spans.
Additional logic for medical claim fields:
   ADMIT_TYPE_CD: Assign −2 when the carrier gives a value not listed in the lookup. For unknown use 9 in the xwalk
   DISCHARGE_DISPOSITION_CD: Assign −2 when the carrier gives a value not listed in the lookup. For unknown use −1 in the xwalk
   TYPE_OF_SERVICE_CD: Assign −2 when the carrier gives a value not listed in the lookup. For unknown use −1 in the xwalk
   CLAIM_CATEGORY_CD: Derive when possible.
   PLACE_OF_SERICE CD
   Assign −2 when the carrier gives a value not present in the lookup. For unknown use 99 in the xwalk
   PATIENT_RESP_AMOUNT: Set value to zero when not available.
   PATIENT_COINSURANCE: Set value to zero when not available.
   BILLED_AMOUNT: Default to zero if not available
   CLAIM_STATUS: Map denial status if sent. Otherwise, send it as ‘P’.
   DRG_CD: Set to 999 when populated with DRG type other than MS-DRG or CMS-DRG.
   DRG_TYPE: Needs to filled with MS-DRG or CMS-DRG (only v24 drg_cd will be valid)
   DRG_VERSION: Needs to filled when drg_cd is filled. only for use with MS-DRG and CMS-DRG for now. Use MAP_DRG_VERSION_XWALK.
Additional logic for pharmacy claim fields:
   ADJUSTMENT_CD: A for reprocessed originals (no pickup). You can have multiple A,R for the same prescription/fill/date_filled.
   PATIENT_RESP_AMOUNT: Set value to zero when not available.
   CLAIM_STATUS: Map denial status if sent. Otherwise, send it as ‘P’.
Additional logic for provider fields:
   PROVIDER_SPECIALTY_CD: Assign −2 when the carrier provides a value not in the lookup. For values passed as ‘unknown’ by the carrier, set to 99 in xwalk. When null, set to −1. Associate nurses with the provider specialty instead of a nursing specialty, i.e. OB/GYN nurse would have a specialty of OB/GYN
Additional logic for pharmacy fields:
   PHARMACY_NAME: set to ‘Unknown’ if null

The above rules are merely exemplary and many variations may be included or expanded upon for particular implementations.

### Person Matching

The third overall operation is person matching of people in the data. Person matching operation 500 is shown in some detail in FIG. 5. The first step 502 in this operation is assigning a de-identified ID or code from one data source for each person from that source. A consistent de-identified code is used to de-identify each person that does not include any personally identifiable information (PII) or personal health information PHI for that individual. The second step in this process is to relate the de-identified code for each person with the de-identified code in a second source, and so on for each data source. Then the health data points for each source are tied to the person's health experience. Thus the operation is to tie the person's health experience of each data source together in order to view the total experience of the person. The attributes of this total experience will allow more accurate stratification into risk category and appropriateness of care groups.

After processing step 502, an identifier from a subsequent health data source may be matched with the assigned identifier of an individual in matching operation 504. The identifier from the health data source for the individual is preferably a de-identified code. In one embodiment, the de-identified code from each health data source may be different for each individual. In an alternative embodiment, the de-identified code from each health data source may be the same for a given individual. For example, the de-identified code determined in operation 502 for an individual may be X. For individual X, the de-identified code from a medical health data source may be A, from a pharmacy health data source may be B, and from a dental health data source may be C. In another example, the de-identified code for an individual may be X and the de-identified code from medical, pharmacy, and dental health data sources may be A. In this example, the de-identified code X is matched with the de-identified code A. A matching string based on the Member files (which include person and eligibility information) is constructed. This matching string is determined based on a selected person matching scenario used for each customer and can be a de-identified code. A detailed description of person matching scenarios and matching strings is set forth below.

Once the de-identified code of an individual is matched with the de-identified code of each health data source, a health portfolio containing the individual's complete health experience may be produced. For example, individual X's health portfolio is produced in operation 506. Individual X's medical, pharmacy, and dental data is produced. In this example, the medical health data source indicates that individual X has had medical diagnosis A, and medical procedure B. The pharmacy health data source indicates that individual X has had prescriptions A, B, and C. The dental health data source indicates that individual X has had dental treatment A, and dental diagnosis B. The health portfolio may include additional data such as individual X's age, sex, and ethnicity, to name a few. The health portfolio may include additional health data sources such as vision, self-reported, and health risk assessment, to name a few. The health portfolio may include as many health data sources as is needed to produce a complete health portfolio such that healthcare costs may be reduced.

The following details for one implementation of person matching in accordance with this disclosure is provided below.

Depending on the person-matching scenario(s) chosen, we will ask for the fields below to be included, to enable matching of individuals across data sets from different providers:
EMPLOYEE_NO=Employee ID
   This is a number assigned by the employer to each employee.
   This should not be the same as SSN.
SSN=Masked Social Security number (last 4 digits, or more depending on the group size)
   We may also use the full 9-digit SSN
CLEAR_MEMBER_NO=Member ID (as opposed to the de-identified Member ID also included)
A cross-reference table to relate Member IDs across data providers

These fields will be provided for all primary subscribers' records, and may also be provided for dependents.

### Last Resort Fields (PHI)

If the person-matching fields above do not provide adequate information to match people, we may request additional fields:
First and last names
Date of birth

### General Approach

We will ask each data provider which of the “Additional fields to enable person-matching” they can provide, and whether they are available for all members or only for subscribers. We should expect that each data provider might not be able to provide all fields.

Using the scenarios described below, we will determine, of the fields we could receive from each data provider, whether all data providers will be able to be linked together.

There are two general ways data providers can be linked. Two or more data providers that can use the same scenario can link all together on that scenario. If there are some data providers that can use one scenario, other data providers that can use another scenario, and at least one that can use both, then all of these can be linked together.

If a medical or pharmacy data provider cannot be linked, using one of the 5 scenarios, to any other data provider, then we must use the Last Resort scenario to link that provider to at least one other provider.

If a dental, vision, or other data provider cannot be linked, we will not person-match their data.

For Matching when Custom Mapping Data

It is likely that for many customers, we will receive data in a carrier's own format, rather than in Healthentic's preferred format. The carrier's format is likely to include some of the “Last resort” PHI fields which would enable more accurate and complete person matching. We will also likely receive only those “Additional fields” which are already present in the carrier's file format. For these reasons, the most effective way to match people when we are custom-mapping the data will be to match the people during data mapping, and produce mapped files with some consistent way of identifying people. The best scenario (of those below) to use for this is scenario 8: a consistent value in MEMBER_NO for an individual across carriers.

### Scenarios

There are multiple scenarios based on which optional fields will be included, which fields are used to match people, and whether the matching is for primary subscribers only, or for all members. The scenarios are roughly in the order of Healthentic's preference.

In some scenarios, the additional person-matching field(s) are only available for primary subscribers, and not for all members. For those scenarios, dependents will be matched by first matching their primary subscriber, then using gender and year of birth to differentiate between multiple dependents of the same subscriber. This has the limitation that dependents who share gender and year of birth (such as twins) cannot be distinguished.

### 1) Employee Number for Subscribers

Primary subscribers are uniquely identified by an Employee Number, which is assigned by the employer and available in data feeds for all data providers. The primary subscribers are matched across data sets by this Employee Number.

Note: It is assumed that dependents cannot be assigned an Employee Number (because they are not employees), so there is no scenario to match all members by Employee Number.

### 2) Masked Social Security Number for all Members

In this scenario, a masked Social Security number is provided for each member. Typically, the last 4 digits of the SSN will be used (i.e., masking the first 5 digits). Members are then matched across data sets by combining this masked SSN with the year of birth, and gender.

This combination of fields is not unique for each person, but it is estimated that the combination will result in unique values for 95% of the population or more, in groups of 30,000 members or less. For larger groups, it may be necessary to have all but the last 5 digits masked.

It is possible that additional fields, such as dependent status and coverage eligibility dates, may resolve cases where the above combination of fields is not unique.

### 3) Masked Social Security Number for Primary Subscribers

This is the same as scenario 2, but the masked SSN is available only for primary subscribers. The subscribers are matched the same as in scenario 2, and dependents for each subscriber are matched using year of birth and gender.

4) Member IDs with Reference Table, for all Members

In this scenario and the next, each data provider (carrier) has assigned each member an ID, but these IDs are not shared among carriers. This requires an additional data source, which is a crosswalk table showing the relationship of Member IDs across carriers. This crosswalk table would be generated by the employer or some other party who has access to member lists for all carriers and any additional information to determine which member IDs refer to the same people.

People are matched via the crosswalk table:

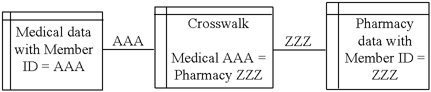

(This example shows only medical and pharmacy data, but this would apply to all data sources that need to be matched, including dental, disability, etc.)
5) Member IDs with Reference Table, for Subscribers

This is the same as scenario 4, except the Member IDs and crosswalk are provided just for subscribers, and dependents are matched as in scenario 3.

### 6) Names and Birth Dates, for all Members

This scenario is similar to the way matching was done for the original Medical-Dental Savings Assessments and the first release of WDE. Each data provider includes identifying information about each member, and these fields are used to match people across data sets. This requires some degree of fuzzy matching to account for spelling variations in the names.

### 7) Names and Birth Dates, for Subscribers

This is the same as scenario 6, but with identifiers provided only for subscribers.

### 8) Member ID

This matches on the MEMBER_NO field only. For this scenario, all data providers must use the same MEMBER_NO for a given person. This scenario will also be used for data which is person-matched internally by Healthentic as part of custom data mapping. Note that this is the de-identified MEMBER_NO which is always included in the MEMBER file; it is NOT the CLEAR_MEMBER_NO.

### 9) Full SSN for all Members

Similar to scenario 2, but with the full SSN provided instead of the last 4 digits. This would only use SSN and not Year of Birth or Gender.

### 10) Full SSN for Primary Subscribers

Along with Scenario 9, this would also use full SSN but only for subscribers. Dependents would be matched the same way as in other scenarios, by matching subscribers first and then dependents using Year of Birth and Gender.

### Implementation

Each person will have one or more “matching values”. A matching value is a string made up of the combination of fields used for matching, depending on the scenario, plus the scenario number itself. Records in different data sets, for the same customer, that have the same matching value, refer to the same person. A single person may have multiple matching values. The matching value depends on the scenario. Most fields here come from the RAW MEMBER table:

| Scenario | Matching value |
|---|---|
| 1 (subscribers) | EMPLOYEE_NO |
| 1 (dependents) | subscriber's EMPLOYEE_NO + own (YEAR_OF_BIRTH + GENDER) |
| 2 (all) and 3 (subscribers) | SSN + YEAR_OF_BIRTH + GENDER |
| 3 (dependents) | subscriber's (SSN + YEAR_OF_BIRTH + GENDER) + own |
| | (YEAR_OF_BIRTH + GENDER) |
| 4 (all) and 5 (subscribers) | PERSON_CLEAR_MEMBER_NO_XREF.CUSTOMER_PERSON_ID |
| 5 (dependents) | subscriber's |
| | (PERSON_CLEAR_MEMBER_NO_XREF.CUSTOMER_PERSON_ID) + |
| | own (YEAR_OF_BIRTH + GENDER) |
| 6 (all) and 7 (subscribers) | FIRST_NAME + LAST_NAME + DATE_OF_BIRTH |
| 7 (dependents) | subscriber's (FIRST_NAME + LAST_NAME + DATE OF BIRTH) + |
| | own (YEAR_OF_BIRTH + GENDER) |
| 8 (all) | MEMBER_NO |

Known matching values will be saved in a Person Matching Lookup table something like this:

| Column | Description |
|---|---|
| CUSTOMER_ID | identifies the customer |
| MATCHING_VALUE | string built using the rules above |
| PERSON_ID | the person associated with the matching value |
| IS_INDEPENDENT | possible column to help clarify whether to |
| | match this person as a dependent or not (this |
| | may be misleading if the person is both a |
| | dependent and a subscriber) |
| SCENARIO | scenario used to construct this matching_value |
| | string |

The primary key of this table is CUSTOMER_ID+SCENARO+MATCHING_ALUE.

This requires a sequence for loading files.

If available, the additional table PERSON_CLEAR_MEMBER_NO_XREF must be loaded first. All Member files must be loaded next in order to create any new Eligibility and Person records.

If a customer's data providers are using a mix of different scenarios, then their Member files should be loaded in an order such that each data provider has a scenario in common with a data provider that has already been loaded.

Claims get loaded after Member files.

When loading a customer's Member file (which includes all person and eligibility information), the general steps will be:
Assemble all “matching values” present in the Member file, for all scenarios supported by the data provider.
Look up the person_id in Person Matching Lookup for each matching value.
Also look up the person_id in Person_Eligibility for each member_no/data_provider_id combination.
If both of these return no results, it's a new person, so add a row to the Person table.
If the Person Matching Lookup did not return a result, add a row to that table using either the Eligibility person_id or the one for the new Person row.
If the different lookups returned different values, merge the existing Person records.
The above process could be done either row by row or for whole record sets.

When loading claims, the general process is:
The claim includes a MEMBER_NO (usually specific to one data provider).
There should be an existing Eligibility record for that MEMBER_NO, which has a Person_ID.
This is the Person_ID to use for claims.
(In other words, the Person Matching Lookup table is not used for claims.)

How this will work to match people:
In the normal case, a person will have matching values that match across all data providers. The first data provider to be loaded will generate the person record and the lookup record; subsequent data provider loads will find the person_id in this lookup.
If there is a duplicate in one data provider's data, they should still have the same matching values. This would generate one person_id.
If a person has different matching values in one data set but the same member number, they will be identified as one person because of the single member number. Either set of matching values could be used by other data providers to identify this person.

As an example, assuming person matching scenario 1 is used for a customer, Subscriber Employee Number will be used as matching string among different data providers. If medical data is loaded first, a person record X is generated for an individual with Subscriber Employee Number A. If pharmacy data is loaded next and there exists a subscriber with Employee Number A, the system will “person match” and recognize this as the same person X. If dental data is then loaded and there also exists a subscriber with Employee Number A, the system will ‘person match again and recognize this as the same person X. As a result of this example, the medical, dental and pharmacy data of person X can be linked to reflect this individual's whole health without the use of PHI or PII., only person X. It is to be understood that this example, above, is merely illustrative, representing matching “without PHI” depends on the data format being determined by an expert to be de-identified. The person matching fields (Subscriber Employee Number in this example) actually are PII unless that expert determination is made.

### Analyze Population

The analysis operation is shown in FIG. 3. Here, algorithms for each individual are utilized in order to assign risk and conditions to each de-identified individual in the population. Next, an appropriateness of care algorithm set is run. These algorithms place each de-identified person in the population into a care category based on age, sex, condition, and health history. The algorithms to determine which persons have which conditions are based on medical, pharmacy and/or dental claims data and rely on such information as diagnoses, procedures, prevalence of visits to certain facilities, i.e. ER or Hospital, and prescriptions for drugs known to treat the conditions identified. Exemplary definitions and algorithms for various conditions are provided below.

### Condition/Risk Identification:

Diabetes (modified based on HEDIS 2012 technical specification Volume 2 p 147)
   Members had one or more of following medications (TC_GPI_Name_level_{—}1=‘ANTIDIABETICS’
      Alpha-Glucosidase Inhibitors
      Antidiabetic—Amino Acid Derivatives
      Antidiabetic—Amylin Analogs
      Antidiabetic Combinations
      Biguanides
      Diabetic Other
      Dipeptidyl Peptidase-4 (DPP-4) Inhibitors
      Incretin Mimetic Agents
      Meglitinide Analogues
      Sulfonylureas
      Insulin Sensitizing Agents
      Insulin
         or
   Members had at least two face-to-face encounters in an outpatient setting or nonacute inpatient setting on different date of service (within one year) with any diagnosis of diabetes (ICD-9-CM in 250.xx, 362.0x, 357.2, 366.41) and CPT codes 92002, 92004, 92012, 92014, 99201-99205, 99211-99215, 99217-99220, 99241-99245, 99341-99345, 99347-99350, 99384-99387, 99394-99397, 99401-99404, 99411, 99412, 99420, 99429, 99455, 99456, 99304-99310, 99315, 99316, 99318, 99324-99328, 99334-99337 or
   Members had at least one ER visit or one hospitalization with any diagnosis of diabetes, ICD-9-CM in 250.xx, 362.0x, 357.2, 366.41 or
   Above criteria 12 month prior to measurement year
Asthma (modified based on HEDIS 2012 technical specification Volume 2 p 123)
   Members had two or more office visits (within one year) on different dates of service with primary diagnosis code ICD-9-CM 493.xx or
   Members had one office visits with primary diagnosis code ICD-9-CM 493.xx and had one of following medications (TC_GPI_Name_level_{—}2): Antiasthmatic—Monoclonal Antibodies, Asthma and Bronchodilator Agent Combinations, Bronchodilators—Anticholinergics, Leukotriene Modulators, Sympathomimetics, Xanthines or
   Members had at least one Steroid inhalants if asthma medical claims are absent or
   Member had at least one hospitalization or at least one ER visit with primary diagnosis code 493.xx
Hypertension (modified based on HEDIS 2012 technical specification Volume 2 p 136)
   Taking at least two different following therapeutic class of medications (TC_GPI_Name_level_{—}1)
      ANTIHYPERTENSIVES
      BETA BLOCKERS
      CALCIUM CHANNEL BLOCKERS
      DIURETICS
         or
   Members had at least one outpatient encounter with CPT codes: 99201-99205, 99211-99215, 99241-99245, 99384-99387, 99394-99397 and any diagnosis codes ICD-9-CM 401.1, 401.9 or
   At least one ER visit or one hospitalization with any diagnosis codes diagnosis codes ICD-9-CM 401.1, 401.9
Hyperlipidemia
   Members had any combination of two or more ER and/or office visits on different dates of service with any diagnosis codes ICD-9-CM 272.x or
   Members had at least one hospitalization with any diagnosis code s ICD-9-CM 272.x or
   At least taking one of antihyperlipidemics (TC_GPI_Name_level_{—}1) medications
Heart disease (modified based on HEDIS 2012 technical specification Volume 2 p 132)
   Members had at least one office visit or one ER visit or one hospitalization with any ICD-9-CM 410.xx, 411.xx, 412.xx, 413.xx, 414.00-414.07, 414.2, 414.8, 414.9, 428.xx, 429.2, 414.3 or
   CPT code 92980, 92982, 92995, HCPC code G0290 or ICD9-CM procedure code 00.66, 36.06, 36.07 (identify percutaneous coronay interventions, PCI) or
   Place of service is inpatient and
      CPT codes 33510-33514, 33516-33519, 33521-33523, 33533-33536, HCPC code S2205-S2209 or
      ICD9-CM procedure 36.1x, 36.2 (identify coronay artery bypass graft, CABG)
   Above criteria 12 month prior to measurement year

The above examples of algorithms are merely that, examples. Similar algorithms are utilized for most known ailments, conditions and diagnoses. Each individual may be placed into a care category based on the individual's risks and conditions, age, sex, and health history. A care category is a categorization of individuals based on how they utilize the health services of the carrier/customer. For example, the care categories may include healthy, preventable and chronic. Therefore each person is assigned a Health Category based on their claims experience. To determine a person's Health Category, demographic information such as age and gender are considered in conjunction with a person's assign Risks and Conditions (if any) as well as their overall claims experience (related to Risks & Conditions or not). Exemplary definitions for the Health Category are set forth below.

Health Categories Based on Claims Utilization (Require Both Medical and Pharmacy Data)
Healthy: members without any chronic diseases (diabetes, hypertension, hyperlipidemia, asthma, depression, cancers, cardiovascular disease, CHF, CKD, ESRD) in reporting period
   Members with at least one medical claim and/or one pharmacy claims:
      number of ER visits plus number of non-preventive office visits<=3 and
      no hospitalizations except normal delivery CMS DRG 373 or, MS DRG 775 and normal baby CMS DRG 391 or MS DRG 795)
   Members without medical and pharmacy claims
      Male age 19-45
Preventable: members without any chronic diseases (diabetes, hypertension, hyperlipidemia, asthma, depression, cancers, cardiovascular disease, CHF, CKD, ESRD) in reporting period
   Members with at least one medical claim and/or one pharmacy claim
      number of ER visits plus non-preventive office visits>3 or
      having at least one hospitalization excluding normal babies and normal deliveries CMS DRG 373, 391 or MS DRG 775, 795
   Members without medical and pharmacy claims
      female member or
      male<19 or >45 or
      unknown age or unknown gender
Chronic:
   members with one of following chronic diseases—diabetes, hypertension, hyperlipidemia, asthma, depression, cancers, heart disease, CKD, and ESRD
   Subgroup:
   1) Chronic Mild: members had ER visits ≦3 and without hospitalizations (except normal delivery)
   2) Chronic Moderate/severe: members had ER visits >3 or with at least one hospitalization (except normal delivery)

### Stratify Population

As noted above, each individual may be placed into a care category based on the individual's risks and conditions, age, sex, and health history. After each individual of a population is placed into a category an analysis is done on each individual's risk and condition for each care category.

First, all de-identified persons in a population may be counted into risks and conditions for each care category. The most frequent risks and conditions can then be determined. Then migration between the care categories is tracked or monitored to give clear indications of what actions need to be taken to increase the overall health of the group, or population being considered. In addition, the most frequent risks and conditions that have the greatest impact for that category can be determined. In order to impact the population's health risk, the highest impact areas can be selected, since these will likely have the greatest success.

For example, an analysis of each individual in the preventable category may produce data indicating the most frequent risks and conditions for the preventable category. The population's health risk may be impacted based on this data because the most frequent risks and conditions may be analyzed for the population. In one embodiment, a population may be monitored as the population migrates from one care category to another. This may result in the implementation of strategies to increase the overall health of the population. For example, for each health category, the measurement year results and a year prior measurement can be compared and represented by “Got Better”, “No Change” and “Got Worse” groups.

### Identify Opportunities

First, the risks and or conditions that need to be managed are identified. In particular, feedback from the care category grouping, as well as the frequency of the risk or condition are preferably utilized to identify the risks and/or conditions that need to be addressed. Then, for each risk or condition group, there may be multiple approaches and multiple providers to address the population. For example, for a Diabetes population, one can focus on strategies to Manage Conditions and Promote Health. Some strategies to promote health include a weight control education campaign, a nutrition education campaign, and a diabetes education. Some strategies to manage conditions may include diabetes medication adherence and kidney disease screening programs. For each of the strategies, program documents such as brochures, flyers, tip sheets, supporting research and publications may be provided as well as an implementation plan, business case to get customer buy in, and success metrics for measurement may be provided to promote successful implementation of each program. Finally, for each condition group a consistent set of target metrics is identified to measure the approach and vendor efficacy.

### Track Results

The final operation 222 of the overall process 200 shown in FIG. 2 is to turn the risk/condition population into a cohort. Thus each individual of a population may be monitored and/or tracked. When data for each individual is updated, this data may be tracked to allow adjustment to be made to programs for each individual and/or a population. This tracking tool includes two types of reporting metrics: The first is outcome metrics and the second is activity success metrics. Outcome metrics are the metrics that can be seen in the clinical or claims data over time. This would include condition prevalence, number of risks, costs, medication experience, and other indicators of program success. In this case one is able to track the conditions themselves, the results can be updated whenever a change is noted throughout the process. One can also use the tracking to make adjustments to programs and report results.

In one embodiment, the several web servers and application servers, e.g., 106, 110, and 112 are implemented on separate computers connected via a local area network (and/or intranet or Internet). Alternatively, at least the some of the servers can be implemented on a same computer. In one embodiment, the servers are coupled via a network. Alternatively, one server may be configured to use one or more of other servers that are not shared by another server.

From this description, it will be appreciated that certain aspects are embodied in the user devices, certain aspects are embodied in the server systems, and certain aspects are embodied in a system as a whole. Embodiments disclosed can be implemented using hardware, programs of instruction, or combinations of hardware and programs of instructions.

In general, routines executed to implement the embodiments may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The instructions may be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Aspects disclosed may be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

In various embodiments, hardwired circuitry may be used in combination with software instructions to implement the techniques. Thus, the techniques are neither limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

Although the disclosure has been provided with reference to specific exemplary embodiments, it will be evident that the various modification and changes can be made to these embodiments without departing from the broader spirit as set forth in the claims. Accordingly, the specification and drawings are to be regarded in an illustrative sense rather than in a restrictive sense.

What is claimed is:

1. A method of tracking health care metrics over time comprising:
aggregating health related data via computer in a common computer database;
de-identifying persons in the data in the database to remove personally identifiable information (PII) and personal Health information (PHI);
matching de-identified persons with the related data;
analyzing the matched de-identified persons and related data to generate populations utilizing risk, condition, and appropriateness of care algorithms,
stratifying the population into predefined groups,
identifying opportunities for health improvement; and
disseminating the opportunities to the persons in the groups; and
tracking the groups over time to ascertain success of the opportunities disseminated.

2. The method according to claim 1 wherein aggregating health related data comprises collecting data from patients, medical insurance carriers, medical and dental service providers, hospitals and pharmacies.

3. A method comprising:
aggregating, utilizing a computing device having a processor operably connected to a database, health care related data associated with patients from sources selected from the group consisting of health insurance carriers, medical providers, dental providers, pharmacies, vision correction providers and individuals;
generating, using the computing device, a unique identifier for each patient that contains no personal health information (PHI) or personally identifiable information (PII);
matching, using the computing device, the health care related data to the unique identifiers;
analyzing, using the computing device, patient population risks based on the matched health care related data;
identifying, using the computing device, opportunities for health improvement; and
generating suggestions for improvement for members of the patient populations.

4. The method according to claim 3 wherein the aggregating comprises collecting data in a common database and de-identifying individuals associated with the data across all data fields so as to remove all PII and PHI.

5. The method according to claim 4 further comprising linking the de-identified individuals to the data to generate the populations.

6. The method according to claim 3 further comprising stratifying, using the computing device, the populations into predefined risk, condition, and appropriateness of care groups.

7. The method according to claim 6 wherein the groups are healthy, preventable and chronic.

8. The method according to claim 3 wherein the generating includes decrypting the data.

9. The method according to claim 8 wherein matching includes mapping the health related data to a standard database format following decryption.

10. A system comprising:
a computing device having a processor operably connected to a common database and communicatively coupled to health related data sources to receive health related data from those sources, wherein the computing device is programmed to:
aggregate the health related data in the common computer database;
de-identify persons in the data in the database to remove personally identifiable information (PII) and personal Health information (PHI);
match de-identified persons with the related data;
analyze the matched de-identified persons and related data to generate populations utilizing risk, condition, and appropriateness of care algorithms,
stratify the population into predefined groups,
identify opportunities for health improvement; and
disseminate the opportunities to the persons in the groups; and
track health data for the groups over time to ascertain success of the opportunities disseminated.

11. The system according to claim 10 wherein the computing device is programmed to collect health related data in the common database and de-identify individuals associated with the data across all data fields so as to remove all PII and PHI.

12. The system according to claim 11 wherein the computer is further programmed to link the de-identified individuals to the data to generate the populations.

13. The system according to claim 12 wherein the computer is further programmed to stratify the populations into predefined risk, condition, and appropriateness of care groups.

14. The system according to claim 13 wherein the groups are healthy, preventable and chronic.

15. The system according to claim 11 wherein the computer is further programmed to decrypt the data.

16. The system according to claim 15 wherein the health related data is mapped to a standard database format following decryption.

17. A tangible machine readable medium storing instructions that, when executed by a computing device, cause the computing device to perform a method, the method comprising:
aggregating health care related data associated with patients from sources selected from the group consisting of health insurance carriers, medical providers, dental providers, pharmacies, vision correction providers and individuals;
generating a unique identifier for each patient that contains no personal health information (PHI) or personally identifiable information (PII);
matching the health care related data to the unique identifiers;
analyzing patient population risks based on the matched health care related data;
identifying opportunities for health improvement; and
generating suggestions for improvement for members of the patient populations.

18. The medium according to claim 17 wherein the aggregating comprises collecting data in a common database and de-identifying individuals associated with the data across all data fields so as to remove all PII and PHI.

19. The medium according to claim 18 further comprising linking the de-identified individuals to the data to generate the populations.

20. The medium according to claim 18 further comprising stratifying, using the computing device, the populations into predefined risk, condition, and appropriateness of care groups.
